(19) United States
(12) Patent Application Publication
(10) Pub. No.: US 2014/0038473 A1
(43) Pub. Date: Feb. 6, 2014

(54) TERMINAL FITTING

(71) Applicants: Hiroshi Kojima, Makinohara-shi (JP); Takashi Tsukamoto, Makinohara-shi (JP)

(72) Inventors: Hiroshi Kojima, Makinohara-shi (JP); Takashi Tsukamoto, Makinohara-shi (JP)

(73) Assignee: YAZAKI CORPORATION, Tokyo (JP)

(21) Appl. No.: 14/112,756

(22) PCT Filed: Apr. 17, 2012
(86) PCT No.: PCT/JP2012/002638

§ 371 Date: Oct. 18, 2013

(30) Foreign Application Priority Data
Apr. 22, 2011 (JP) 2011-095944

(51) Int. Cl. H01R 13/18

(52) U.S. Cl. CPC H01R 13/18
USPC 439/851

(57) ABSTRACT

The present invention provides a terminal fitting that ensures constant contact load of an inserter that is inserted into an electrical contact by making uniform the amounts of displacement among a plurality of resilient pieces constituting the electrical contact. A terminal fitting includes a cylindrical electrical contact portion obtained by making the both ends of the conductive metal plate close to each other and joined to each other. The electrical contact portion includes a plurality of slits extending in a cylinder-length direction N and provided at intervals in the circumferential direction of the electrical contact portion. The slits provided farthest away from the joining portion at the both ends of the metal plate have a size in the cylinder-length direction N larger than those of the other slits.

### TECHNICAL FIELD

The present invention relates to a terminal fitting attached to an end of an electrical wire.

### BACKGROUND ART

An automobile as a movable vehicle incorporates various types of electronic devices Wiring harnesses are used to deliver electrical power and/or control signals to these electronic devices. The wiring harness comprises a plurality of electrical wires and connectors. The connector includes a terminal fitting adapted to be attached to an end of an electrical wire; and a housing having a terminal accommodating portion adapted to accommodate the terminal fitting (for example, see the patent literature PTL 1). FIG. 7 is a perspective view of the conventional terminal fitting. FIG. 8 is a perspective view of the conventional terminal fitting shown in FIG. 7 viewed from another angle. FIG. 9 is a fragmentary view of the conventional terminal fitting shown in FIG. 7 taken along the direction indicated by the arrow A.

The terminal fitting 101 comprises, as shown in FIGS. 7 to 9, a cylindrical electrical contact 102 adapted to be connected to a mating terminal fitting (not-shown); and an electrical contact 104 adapted to be connected to an electrical wire (not-shown). The terminal fitting 101 is inserted in the terminal accommodating portion of the housing (not-shown) from the side of the electrical contact 102 in a state where the electrical contact 104 is connected to the electrical wire.

The electrical contact 102 includes four slits 120. The four slits 120 are provided in a circumferential direction of the electrical contact 102 at equal intervals. The electrical contact 102 is constructed by making the both ends of a conductive metal plate close to each other and joined to each other. The one slit 120 out of the four slits also resides at the both ends of the metal plate at the joining portion 101a (illustrated in FIG. 8).

The slits 120 extend in the longitudinal direction of the electrical co 102 (cylinder-length direction). The four slits 120 have the same size in the longitudinal direction. Also, the electrical contact 102 includes, as shown in FIG. 9, four resilient pieces 120A, 120B, 120C, and 120D obtained by virtue of the presence of the four slits 120.

Next, the mode of connection of the terminal fitting 101 to the mating terminal fitting is described below. First, the inserter of the mating terminal fitting is inserted via the insertion hole 102a (shown in FIG. 8) in the electrical contact 102. The inserter biases the resilient pieces 120A, 120B, 120C, and 120D in the diameter-expansion direction of the electrical contact 102. The outer surface of the inserter and the inner surface of the electrical contact 102 are brought into contact with each other. In this manner, the terminal fitting 101 is connected to the mating terminal fitting 101. In the state where the inserter is positioned inside of the electrical contact 102, the resilient pieces 120A, 120B, 120C, and 120D are energized in the diameter-contraction direction of the electrical contact 102 In this manner, the terminal fitting 101 ensures improved reliability in connection to the mating terminal fitting.

### CITATION LIST

### Patent Literature

[PTL 1]

Japanese Patent Application Aid-Open Publication No. 2004-47355

### SUMMARY OF INVENTION

### Technical Problem

However, the above-described state of the art terminal fitting 101 has the following drawbacks. Specifically, in the case of the terminal fitting 101, as shown in FIG. 10, when the inserter of the mating terminal fitting is inserted via the insertion hole 102a into the electrical contact 102, the amount of displacement of the pair of resilient pieces 120B and 120C that are most proximate to the joining portion 101a among the four resilient pieces 120A, 120B, 120C, 120D is larger than those of the other resilient piece 120A, 120D farthest away from the joining portion 101a. In other words, the pair of resilient pieces 120B and 120C are more readily deformed than the other resilient pieces 120A and 120D. This causes variation in the amounts of displacement among the resilient pieces 120A, 120B, 120C, and 120D, which in turn causes the inserter to fail to obtain a uniform contact load among the resilient pieces 120A, 120B, 120C, and 120D.

An object of the present invention therefore is to provide solution to the above-identified problems. Specifically, one object of the present invention is to provide a terminal fitting that allows for constant contact load of the inserter that is inserted into the electrical contact through making uniform the amounts of displacement of resilient pieces constituting the electrical. contact.

### Solution to Problem

In order to provide a solution to the above-identified problem, a first aspect of the subject matter provides a terminal fitting that comprises: a cylindrical electrical contact made of a conductive metal plate with both ends thereof made close to each other and joined to each other to define a joining portion of the metal plate, the electrical contact including a plurality of slits provided at intervals in a circumferential direction of the electrical contact, the slits extending in a cylinder-length direction which is a direction along a length of the cylindrical electrical contact. Among the slits, one slit that is the farthest away from the joining portion among the slits has a size in the cylinder-length direction larger than those of the remaining slits.

### Advantageous Effects of Invention

The invention according to the first aspect has the following construction and advantageous effects. The cylindrical electrical contact is provided with the both ends of the conductive metal plate made close to each other and joined to each other thereby forming the joining portion of the metal plate. The electrical contact includes the slits provided at intervals in the circumferential direction of the electrical contact. The slits extend in the cylinder-length direction. One of the slits that is the farthest away from the joining portion among the slits has the size in the cylinder-length direction larger than those of the remaining slits. Among the plurality of the resilient pieces defined by the slits, the resilient pieces constituting the electrical contact, the one resilient piece most proximate to the one slit farthest away from the joining portion of the is allowed to be readily elastically deformed in the electrical contact's diameter-expansion direction and diameter-contraction direction. By this fact, when the inserter is inserted into the electrical contact portion and the resilient pieces are elastically deformed in the diameter-expansion direction, the amount of displacement of the resilient piece most proximate to the slit becomes nearer to the amounts of displacement of the resilient pieces most proximate to the joining portion at the both ends of the metal plate, so that the amounts of is displacement of the resilient pieces are made uniform and thereby the contact load of the inserter being inserted in the electrical contact portion can be made constant.

### BRIEF DESCRIPTION OF DRAWINGS

FIG. 1 is a perspective view of a terminal fitting according to one embodiment of the present invention.

FIG. 2 is a perspective view of the terminal fitting illustrated in FIG. 1 viewed from another angle.

FIG. 3 is a perspective view of the terminal fitting illustrated in FIG. 1 viewed from still another angle.

FIG. 4 is a fragmentary view of the terminal fitting illustrated in FIG. 1 taken along the direction of arrow A in FIG. 1.

FIG. 5 is an illustration for describing the effects of the terminal fitting of the invention shown in FIG. 1.

FIG. 6 is a plan view of a derivative example of the terminal fitting shown in FIG. 1.

FIG. 7 is a perspective view of a conventional terminal fitting.

FIG. 8 is a perspective view of the conventional terminal fitting illustrated in FIG. 7 viewed from another angle.

FIG. 9 is a fragmentary view taken in the direction of an arrow B of the conventional terminal fitting illustrated in FIG. 7.

FIG. 10 is an illustration for describing the drawbacks found in the conventional terminal fitting shown in FIG. 7.

### DESCRIPTION OF EMBODIMENTS

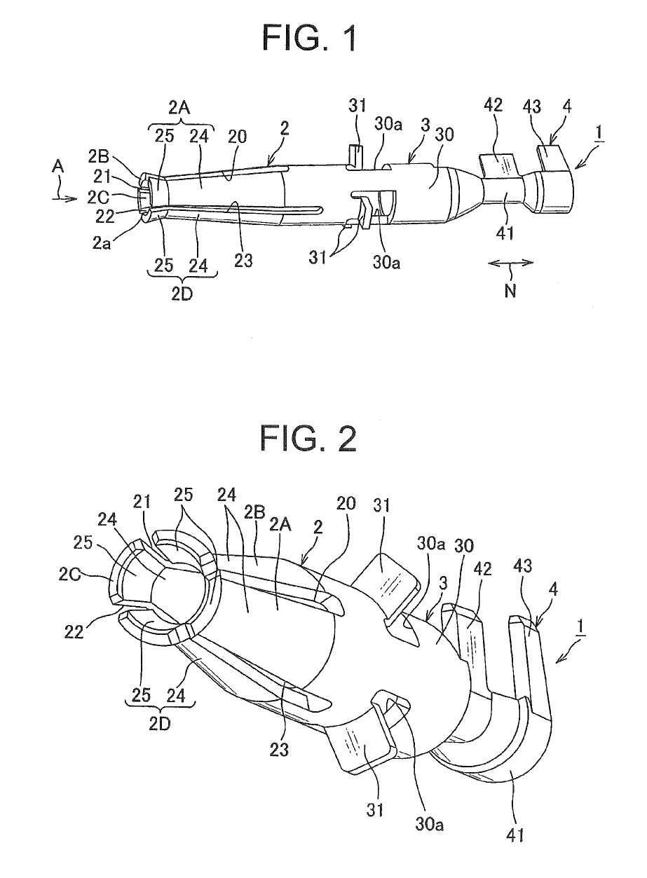

The terminal fitting in accordance with one embodiment of the present invention is described hereinbelow with reference to FIGS. 1 to 4. Referring first to FIG. 1, there is shown a terminal fitting 1 which is a constituent part of a wiring harness arranged in an automobile or other vehicles. The wiring harness comprises: a plurality of electrical wires (not-shown) and connectors (not-shown) each attached to the corresponding one of the ends of the electrical wires. The connectors each comprise the terminal fitting 1; a housing (not-shown) that includes a terminal accommodating portion (not-shown) accommodating the terminal fitting 1; and a rear holder (not-shown) adapted to be attached to the housing to prevent the terminal fitting 1 from being detached from the terminal accommodating portion. The housing is made of insulating synthetic resin.

The terminal fitting 1 comprises, as shown in FIGS. 1 to 3, a cylindrical electrical contact portion 2 adapted to he connected to a mating terminal fitting (not-shown), a cylindrical housing-mounting portion 3 continuing to the electrical contact portion 2, and an electrical-wire-connecting portion 4 continuing to the housing-mounting portion 3 and adapted to be connected to the electrical wire. The terminal fitting 1 is inserted into the terminal accommodating portion of the housing from the side of the electrical contact portion 2 in the state where the electrical-wire-connecting portion 4 is connected to the electrical wire. The terminal fitting 1 (and accordingly the electrical contact portion 2 thereof) is obtained by punching operation for a conductive metal plate and making both ends of the processed metal plate close to each other and joined to each other.

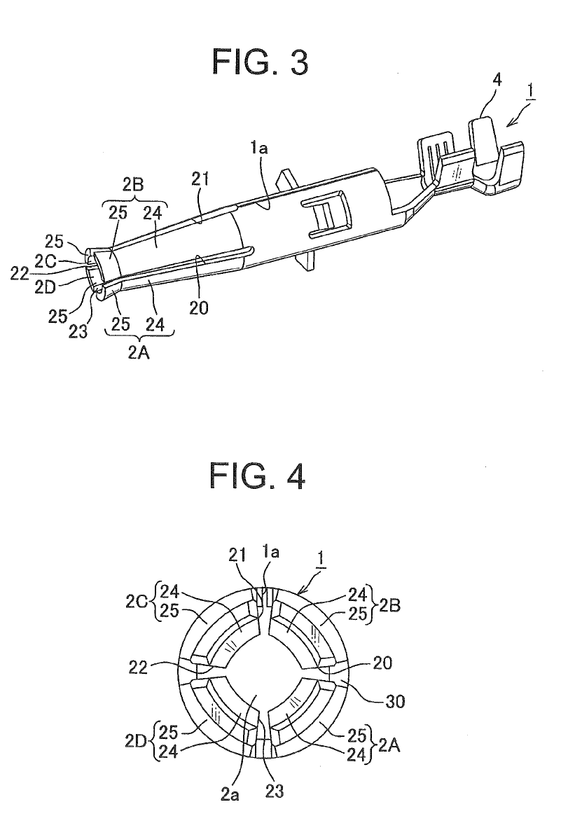

The electrical contact portion 2 includes four slits 20, 21, 22, and 23, which are provided at equal intervals in the circumferential direction of the electrical contact portion 2. With regard to the slit 20, 21, 22, and 23, as shown in FIG. 3, the both ends of the metal plate also resides at the joining portion (hereafter called “joining portion 1a”). In addition, the four slits 20, 21, 22, and 23 extend in the longitudinal direction N of the electrical contact portion 2 (which may be called “cylinder-length direction”). Out of the four slits 20, 21, 22, and 23, the first slit 23 farthest away from the joining portion 1a has a longitudinal direction N larger than those of the remaining three second slits 20, 21, and 22.

Also, the electrical contact portion 2 comprises, as shown in FIG. 4, four resilient pieces 2A, 2B, 2C, and 2D defined by the presence of the four slits 20, 21, 22 and 23. The resilient pieces 2A, 2B, 2C, and 2D each continue to the housing-mounting portion 3, and each include a base 24 that inclines in a diameter-contraction direction, which is such a direction that, due to the presence of the inclined shape of the base, the diameter of the electrical contact portion 2 is gradually decreased as it becomes away from the housing-mounting portion 3; and a diameter-expansion portion 25 that continues to the base 24 and inclines in the diameter-expansion direction, which is such a direction that, in contrast to the diameter contraction direction, the diameter of the electrical contact portion 2 gradually increases due to the presence of the inclined shape of the diameter-expansion portion 25 as the diameter-expansion portion 25 becomes away from the base 24. Also, an inner diameter of the electrical. contact portion 2 at one end thereof continuing to the housing-mounting portion 3 (accordingly, the inner diameter at one end thereof continuing to the housing-mounting portion 3 base 24) is slightly smaller than an outer diameter of an inserter of the mating terminal fitting. It should be noted that, for simplicity, FIG. 4 does not illustrate an abutment piece 31 provided in the housing-mounting portion 3.

Also, the electrical contact portion 2 includes an insertion hole 2a at the other end of the electrical contact portion 2, the other being distal from the one end continuing to the housing-mounting portion 3, and accordingly the insertion hole 2a is provided at one end of the terminal fitting 1. The inserter of the mating terminal fitting is inserted via the insertion hole 2a into the electrical contact portion 2. Also, when the inserter of the mating terminal fitting is inserted in the electrical contact portion 2, the inserter is elastically brought into contact with each of the resilient pieces 2A, 2B, 2C, and 2D. In this manner, the mating terminal fitting and the terminal fitting 1 are placed in electrical connection to each other,

The housing-mounting portion 3 includes a cylindrical circumferential wall 30 continuing to the four resilient pieces 2A, 2B, 2C, and 2D; and three abutment pieces 31 each defined by an integral portion of the circumferential wall 30 bent radially outward of the housing-mounting portion 3. The circumferential wall 30 includes three openings 30a extending through the circumferential wall 30.

The three openings 30a are provided in the circumferential direction of the circumferential wall 30 at equal intervals.

The abutment pieces 31 protrude from one edge of the opening 30a, the one edge being proximate to the electrical contact portion 2, and extend radially outward of the housing-mounting portion 3. The abutment pieces 31 are adapted to be brought into abutment on the rear holder when the electrical wire attached to the terminal fitting 1 is pulled and the terminal fitting 1 is moved in the direction indicated by the arrow N.

The electrical-wire-connecting portion 4 comprises a base wall 41 continuing to the circumferential wall 30 and adapted to position the electrical wire on its surface; a pair of core-wire-clamping pieces 42 protruding upward from the both ends in the width direction of the base wall 41 and adapted to clamp the core wire of the electrical wire therebetween; and a pair of insulating-sheath-clamping pieces 43 protruding upward from the both ends of the base wall 41 in its width direction and adapted to clamp the insulating sheath of the electrical wire. The base wall 41 has a shape of a gutter with cross section in a shape of a circular arc. The pair of core-wire-clamping pieces 42 are provided more proximate to the housing-mounting portion 3 than the pair of insulating-sheath-clamping pieces 43 are.

With regard to the configuration of the electrical-wire-connecting portion 4, when the electrical wire having a circular cross section, the sheath at the end of which is taken away with the core wire exposed to an outside, is placed upon the base wall 41, the core-wire-clamping pieces 42 are bent in the direction where the core wire of the electrical wire is pressed against the base wall 41, i.e., in the direction in which the core wire of the electrical wire is clamped by the core-wire-clamping pieces 42, and the electrical-wire-connecting portion 4 is electrically connected to the electrical wire. Likewise, the insulating-sheath-clamping piece 43 is bent in the direction where the sheath of the electrical wire is pressed toward the base wall 41, i.e., the insulating sheath of the electrical wire is clamped by the insulating-sheath-clamping piece 43 so as to be secured to the electrical wire. In addition, FIGS. 1 to 3 illustrate the state where the core-wire-clamping pieces 42 and the insulating-sheath-clamping pieces 43 are yet to clamp the electrical wire.

Next, the following describes the mode of connecting the terminal fitting 1 having the above-described configuration to the mating terminal fitting. First, the inserter of the mating terminal fitting is moved close to the electrical contact portion 2 of the terminal fitting 1 that is in a state where the terminal fitting 1 is connected to the end of the electrical wire, and the inserter is inserted via the insertion hole 2a into the electrical contact portion 2, and the outer surface of the inserter and the inner surface of the electrical contact portion 2 are brought into contact with each other. The inserter biases the resilient pieces 2A, 2B, 2C, and 2D in the diameter-expansion direction. In this manner, the inserter during the insertion operation makes the resilient pieces 2A, 2B, 2C, and 2D elastically deformed in the diameter-expansion direction. In other words, in the state where the inserter is positioned inside of the electrical contact portion 2, the resilient pieces 2A, 2B, 2C, and 2D are energized in the diameter-contraction direction. In this manner, the terminal fitting 1 is connected to the mating terminal fitting.

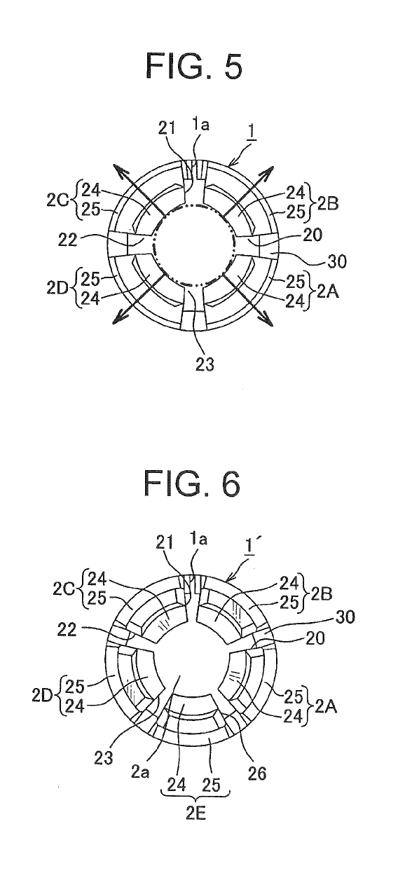

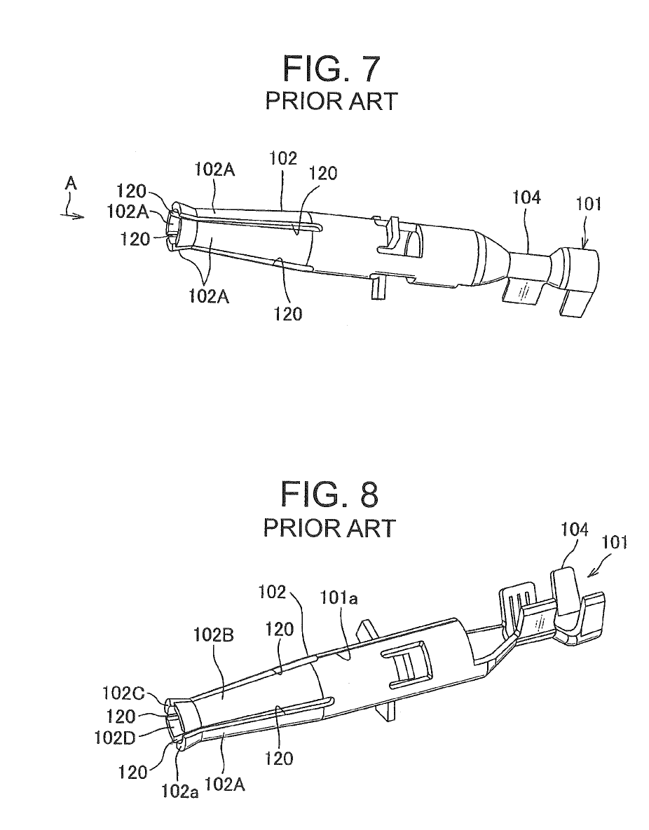

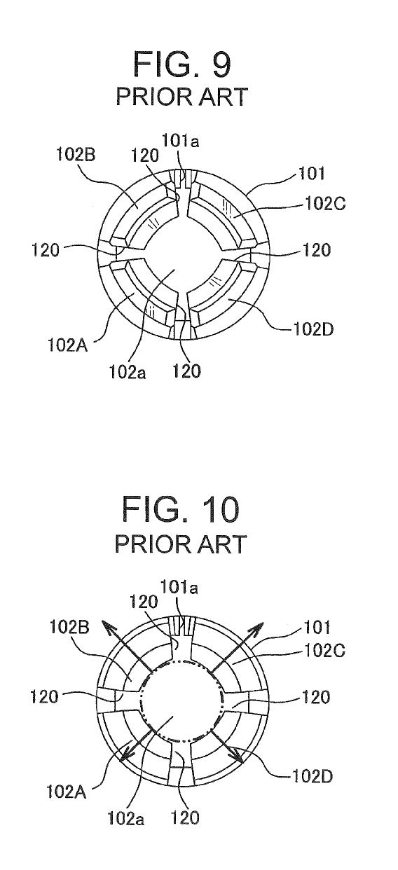

In accordance with the above-described embodiment, the pair of resilient pieces 2A and 2D most proximate to the first slit 23 among the resilient pieces become more readily elastically deformed in the diameter-expansion direction and diameter-contraction direction of the electrical contact portion 2. By this fact, as shown in FIG. 5, when the inserter is inserted into the electrical contact portion 2 and the four resilient pieces 2A, 2B, 2C, and 2D are elastically deformed in the diameter-expansion direction, the amount of displacement of the pair of resilient pieces 2A and 2D most proximate to the first slit 23 becomes nearer to the amount of displacement of the pair of resilient pieces 2B and 2C most proximate to the joining portion 1a at the both ends of the metal plate, so that the amounts of displacement of the four resilient pieces 2A, 2B, 2C, and 2D are made uniform and thereby the contact load of the inserter being inserted in the electrical contact portion 2 can be made constant.

Although the electrical contact portion 2 in the above-described embodiment is formed in a cylindrical shape, the present invention is not limited to this specific configuration, and the electrical contact portion 2 may take a prismatic shape.

Also, although the above-described embodiment provides the four slits 20, 21, 22, and 23, the present invention is not limited to this specific configuration: It suffices that at least three of the slits 20, 21, 22, and 23 are provided. Further, although the slit 21 in the above-described embodiment is provided in the joining portion 1a, the present invention is not limited to this specific configuration: The slits 20, 21, 22, and 23 may be provided at a location other than the joining portion 1a.

Further, although the above-described embodiment provides one first slit 23, the present invention is not limited to this specific configuration: As in the case of the terminal fitting 1′ illustrated in FIG. 6, the electrical contact portion 2 may comprise five resilient pieces 2A, 2B, 2C, 2D, and 2E by virtue of the five slits 20, 21, 22, 23, and 26. Out of the five slits 20, 21, 22, 23, and 26, the two first slits 23 and 26 farthest away from the joining portion 1a has a longitudinal direction N larger than those of the remaining three second slits 20, 21, and 22. In other words, the two first slits 23, 26 may be provided. The same or like elements in FIG. 6 as those of the previously described embodiment are indicated by the same reference sings with detailed description of which is omitted. Also, FIG. 6 does not illustrate the abutment piece 31 of the housing-mounting portion 3 for simplicity.

It is appreciated that the embodiments described herein are representative ones taken out of conceivable embodiments of the invention, and that the invention is in no way limited to the illustrated embodiments. Rather, the invention can be implemented with various modifications made thereto within the range that the spirit of the invention is deviated from.

### Reference Signs List

1, 1′ Terminal fitting
2 Electrical contact
20, 21, 22 Second slit (other slit)
23, 26 First slit (slit)

1. A terminal fitting comprising a cylindrical electrical contact made of a conductive metal plate with both ends thereof made close to each other and joined to each other to define a joining portion of the metal plate, the electrical contact including a plurality of slits provided at intervals in a circumferential direction of the electrical contact, the slits extending in a cylinder-length direction which is a direction along a length of the cylindrical electrical contact, a size in the cylinder-length direction of one of the slits farthest away from the joining portion being larger than those of the remaining slits.
